(19) United States
(12) Patent Application Publication
(10) Pub. No.: US 2024/0370487 A1
(43) Pub. Date: Nov. 7, 2024

(54) Machine-Learned Models for Multimodal Searching and Retrieval of Images

(71) Applicant: Google LLC, Mountain View, CA (US)

(72) Inventors: Severin Heiniger, Zurich (CH); Balint Miklos, Zurich (CH); Yun-Hsuan Sung, San Francisco, CA (US); Zhen Li, Sunnyvale, CA (US); Yinfei Yang, Sunnyvale, CA (US); Chao Jia, Sunnyvale, CA (US)

(21) Appl. No.: 18/253,859

(22) PCT Filed: Nov. 4, 2022
(86) PCT No.: PCT/US2022/048993

§ 371 Date: May 22, 2023

Related U.S. Application Data
(60) Provisional application No. 63/397,589, filed on Aug. 12, 2022.

(51) Int. Cl. G06F 16/538; G06F 16/55; G06N 3/084

(52) U.S. Cl. CPC G06F 16/538; G06F 16/55; G06N 3/084

(57) ABSTRACT

Systems and methods of the present disclosure are directed to computer-implemented method for machine-learned multimodal search refinement. The method includes obtaining a query image embedding for a query image and a textual query refinement associated with the query image. The method includes processing the query image embedding and the textual query refinement with a machine-learned query refinement model to obtain a refined query image embedding that incorporates the textual query refinement. The method includes evaluating a loss function that evaluates a distance between the refined query image embedding and an embedding for a ground truth image within an image embedding space. The method includes modifying value(s) of parameter(s) of the machine-learned query refinement model based on the loss function.

### FIELD

Aspects of the present disclosure relate to searching and retrieval of images. More particularly, aspects of the present disclosure relate to machine-learned models for allowing images to be retrieved from a database in a faster or more efficient manner.

### BACKGROUND

Recently, visual search functionality has been provided as a feature across a wide variety of applications (e.g., virtual assistant applications, camera applications, etc.). Conventionally, when performing a visual search, a user first provides image(s) to a search service. These search services will generally process the image(s) using machine learning techniques to identify visually or semantically similar image(s) and/or information associated with entities depicted in the image(s). However, as these conventional models are trained only to process image data, they cannot incorporate textual query refinements provided by the user.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for machine-learned multimodal search refinement. The method includes obtaining, by a computing system comprising one or more computing devices, a query image embedding for a query image and a textual query refinement associated with the query image. The method includes processing, by the computing system, the query image embedding and the textual query refinement with a machine-learned query refinement model to obtain a refined query image embedding that incorporates the textual query refinement. The method includes evaluating, by the computing system, a loss function that evaluates a distance between the refined query image embedding and an embedding for a ground truth image within an image embedding space. The method includes modifying, by the computing system, one or more values of one or more parameters of the machine-learned query refinement model based at least in part on the loss function.

Another example aspect of the present disclosure is directed to a computing system for machine-learned multimodal search refinement. The computing system includes one or more processors. The computing system includes a machine-learned query refinement model trained to refine a query image with a textual query refinement. The computing system includes one or more non-transitory computer-readable media that store instructions that, when executed by the one or more processors, cause the computing system to perform operations. The operations include obtaining an image embedding for a query image provided by a user of a visual search application. The operations include obtaining, from the user of the visual search application, a textual query refinement for the query image, wherein the textual query refinement is responsive to provision of one or more initial result images for the query image to the user of the visual search application. The operations include processing the image embedding and the textual query refinement for the query image with the machine-learned query refinement model to obtain a refined image embedding that incorporates the textual query refinement. The operations include determining one or more refined result images based at least in part on the refined image embedding that incorporates the textual query refinement.

Another example aspect of the present disclosure is directed to one or more non-transitory computer-readable media that store instructions that, when executed by one or more processors, cause the computing system to perform operations. The operations include obtaining an image embedding for a query image provided by a user of a visual search application. The operations include obtaining, from the user of the visual search application, a textual query refinement for the query image, wherein the textual query refinement is responsive to provision of one or more initial result images for the query image to the user of the visual search application. The operations include processing the image embedding and the textual query refinement for the query image with the machine-learned query refinement model to obtain a refined image embedding that incorporates the textual query refinement. The operations include determining one or more refined result images based at least in part on the refined image embedding that incorporates the textual query refinement.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs machine-learned query refinement according to example embodiments of the present disclosure.

FIG. 1B depicts a block diagram of an example computing device that performs machine-learned query refinement according to example embodiments of the present disclosure.

FIG. 1C depicts a block diagram of an example computing device that performs training of a machine-learned query refinement model according to example embodiments of the present disclosure.

FIG. 2 depicts data flow diagram for training a machine-learned query refinement model for refinement of a visual search query according to some embodiments of the present disclosure.

FIG. 3 depicts data flow diagram for refining a visual search query with a machine-learned query refinement model according to some embodiments of the present disclosure.

FIG. 4 depicts data flow diagram for processing inputs for a machine-learned query refinement model for refinement of a visual search query according to some embodiments of the present disclosure.

FIG. 5 depicts a communication flow diagram for provision of visual search services with query refinement according to some embodiments of the present disclosure.

FIG. 6 depicts a flow chart diagram of an example method to perform training of a machine-learned query refinement model according to example embodiments of the present disclosure.

FIG. 7 depicts a flow chart diagram of an example method to perform query refinement with a machine-learned query refinement model according to example embodiments of the present disclosure.

Reference numerals that are repeated across plural figures are intended to identify the same features in various implementations.

### DETAILED DESCRIPTION

### Overview

Aspects of the present disclosure are directed to the technical task of searching and retrieving images using multimodal search. More particularly, the present disclosure relates to machine-learned models for textual refinement of image queries to form multimodal queries. As an example, a query image embedding for a query image can be obtained with a textual query refinement associated with the query image. For example, the query image may depict a particular person, and the textual query refinement may describe a visual characteristic associated with the particular person (e.g., an item of clothing or a facial feature, such as a beard) that is different than, or not present in, the query image. The query image embedding and the textual query refinement can be processed with a machine-learned query refinement model (e.g., a transformer model, etc.) to obtain a refined query image embedding that incorporates the textual query refinement. To follow the previously described example, the refined query image embedding may be an image embedding for the particular (or at least a visually similar) person with the characteristic described in the textual query refinement. A loss function can be evaluated that evaluates a distance between the refined query image embedding and an embedding for a ground truth image within an image embedding space. One or more values of one or more parameters of the machine-learned query refinement model can be modified based at least in part on the loss function. In such fashion, the machine-learned query refinement model can be trained to refine an image embedding for an initial query image such that the refined image embedding incorporates the textual query refinement, therefore enabling a fast and efficient mechanism for retrieving images and/or other information associated with those images from a database.

Embodiments of the present disclosure provide a number of technical effects and benefits. As one example technical effect and benefit, the technical task of searching and retrieving similar images may be performed in a faster and/or more efficient manner. For instance, users of conventional visual search applications are often required to re-capture images of a query target due to incorrect determination of user intent by the visual search application. In turn, this can lead to a frustrating user experience and unnecessary use of resources to re-capture the query target (e.g., power, compute cycles, memory, storage, bandwidth, etc.). However, embodiments of the present disclosure provide a machine-learned query refinement model that can be leveraged by the visual search applications to provide textual refinement features so that users can quickly and efficiently refine their visual search with textual data, therefore substantially improving efficiency of the search by eliminating unnecessary resource usage associated with re-capturing query target. In addition, as will be appreciated, embodiments of the disclosure may facilitate visual-search-based retrieval of images which may not otherwise be easily retrieved using only the query image.

With reference now to the Figures, example embodiments of the present disclosure will be discussed in further detail.

### Example Devices and Systems

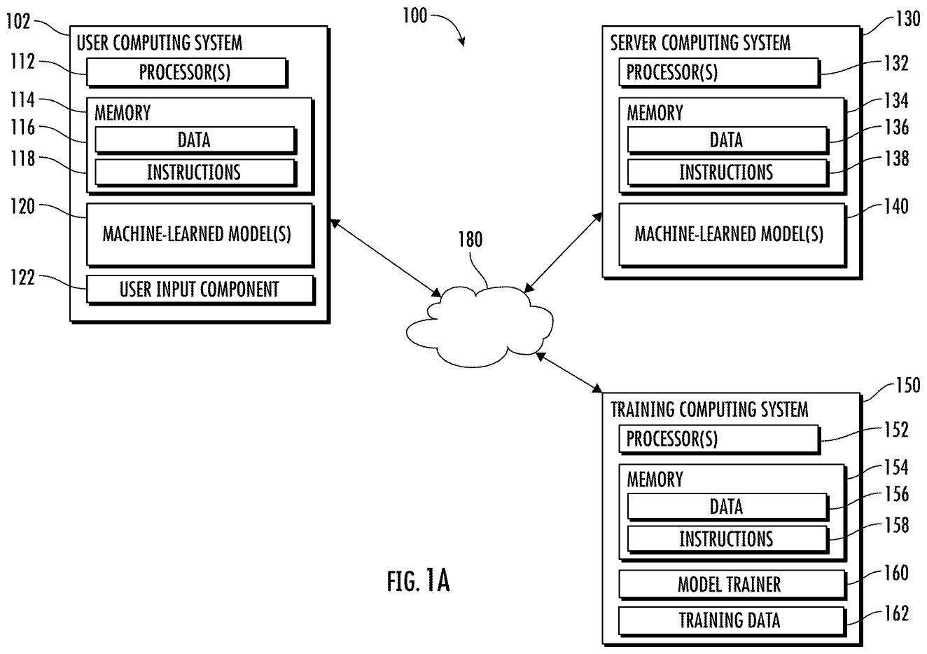

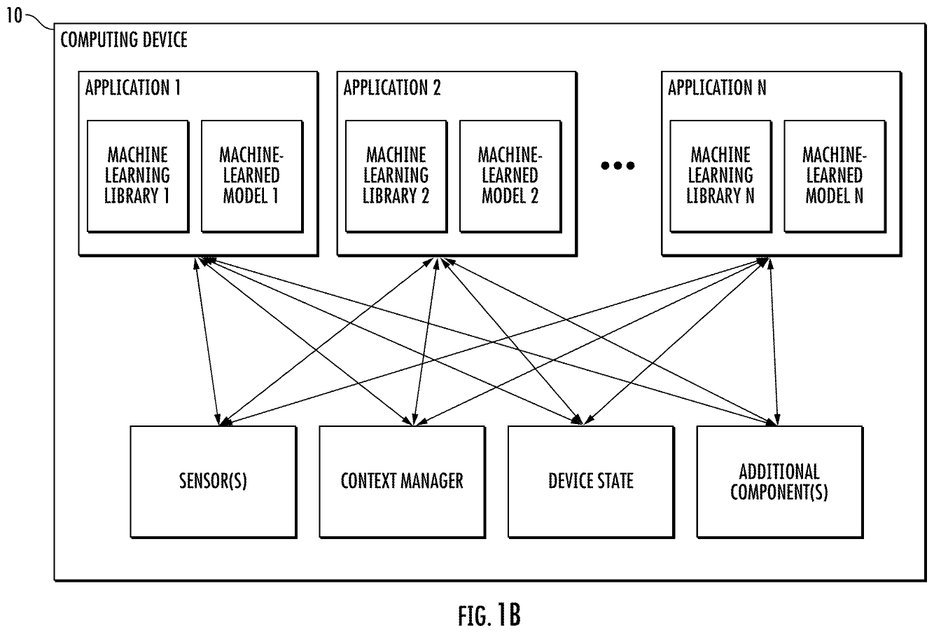

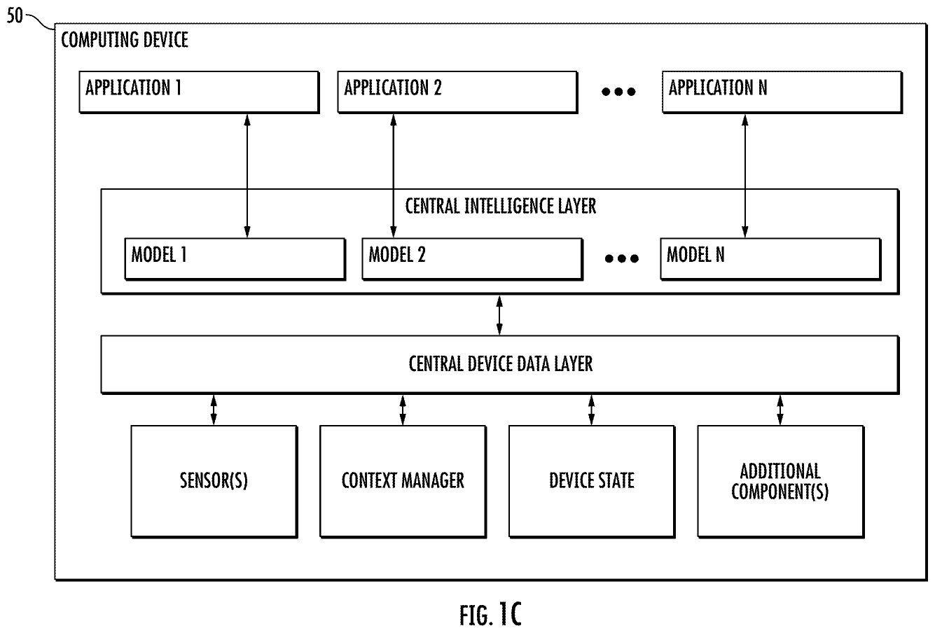

FIG. 1A depicts a block diagram of an example computing system 100 that performs machine-learned query refinement according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

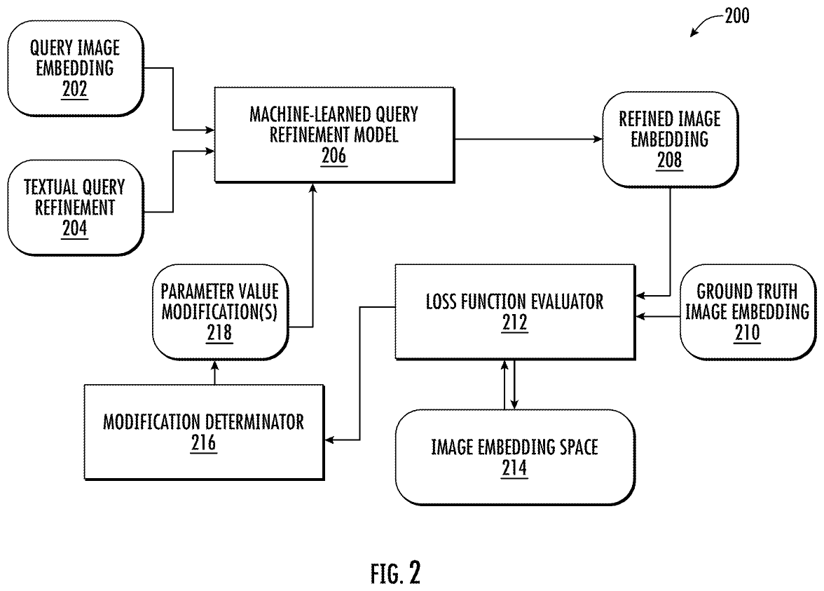

In some implementations, the user computing device 102 can store or include one or more machine-learned query refinement models 120. For example, the machine-learned query refinement models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned query refinement models 120 are discussed with reference to FIGS. 2-5.

In some implementations, the one or more machine-learned query refinement models 120 can be received from the server computing system 130 over network 180, stored in the user computing device memory 114, and then used or otherwise implemented by the one or more processors 112. In some implementations, the user computing device 102 can implement multiple parallel instances of a single machine-learned query refinement model 120 (e.g., to perform parallel query refinement across multiple instances of the machine-learned query refinement model 120).

More particularly, the machine-learned query refinement model 120 can be trained and utilized to refine a query image provided for a visual image search with a textual query refinement. For example, the machine-learned query refinement model 120 can process a query image or a representation of the query image (e.g., an embedding of the query image) concurrently with a textual query refinement or a representation of the query refinement (e.g., token embeddings for the textual query refinement). In turn the machine-learned query refinement model 120 can generate a refined query image embedding that incorporates the textual query refinement. For example, if the query image depicts a particular person, and the textual query refinement is descriptive of the item of clothing “hat”, the refined image embedding may correspond to an image of the person (or a visually similar person) wearing a hat. This refined query image embedding can be utilized to retrieve images associated with image embeddings within a certain distance of the refined image embedding within an image embedding space (e.g., an embedding space for a image search service, etc.). In such fashion, the machine-learned query refinement model 120 can be leveraged to provide textual refinement capabilities for visual search applications.

Additionally or alternatively, one or more machine-learned query refinement models 140 can be included in or otherwise stored and implemented by the server computing system 130 that communicates with the user computing device 102 according to a client-server relationship. For example, the machine-learned query refinement models 140 can be implemented by the server computing system 140 as a portion of a web service (e.g., a query refinement service, a visual search service, etc.). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned query refinement models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-5.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned query refinement models 120 and/or 140 based on a set of training data 162. The training data 162 can include a variety of pairs of image data and associated textual query refinements. For example, in some embodiments, the training data 162 can include a corpus of image search data. The corpus of image search data can describe interactions with search results from users, and can include search result images provided to users responsive to a query, and refined search result images provided to the users responsive to selection of query refinement elements provided to the users with the search result images. The query image, the textual query refinement, and the ground truth image can be selected from the search result images, the selectable query refinement elements, and the refined search result images.

For example, the corpus of image search data may include a plurality of search result images provided to users by an image search service responsive to a textual query (e.g., a textual query of “car”). The corpus of image search data can indicate the search result image interacted with most frequently by users (e.g., an image depicting a black car, etc.). The corpus of image search data can also include refined search result images provided to users responsive to selection of a query refinement element provided to the users with the search result images. For example, the image search service may provide a number of query refinement user interface elements alongside the search result images that can be selected to refine the textual query provided by the user (e.g., elements such as “truck”, “red”, “blue”, “fast”, “van”, etc. for the textual query of “car”, etc.). When a query refinement element is selected by a user, refined search result images can be provided to the selecting user responsive to the textual query and the selected query refinement element. For example, a user may provide an initial textual query of “car” and then may select a query refinement element of “blue.” The refined search result images may each depict a blue car.

The corpus of image search data can indicate the refined search result image interacted with most frequently by users after selection of the associated query refinement element. The query image, the textual query refinement, and the ground truth image can be selected for inclusion within the training data 162 from the search result images, the selectable query refinement elements, and the refined search result images.

For example, a plurality of users may each provide a textual query of “car” to an image search application, and in response, the image search application can provide a plurality of search result images to the users. The corpus of image search data can indicate a first search result image of the plurality of search result images as being interacted with most by the users. Next, the plurality of users can each select the same query refinement element of “blue”. The image search application can provide a plurality of refined search result images depicting blue cars, and the corpus of image search data can indicate a first refined search result image of the plurality of refined search result images as being interacted with most by the plurality of users. The first search result image can be selected as a query image, the textual content of the query refinement element (e.g., “blue”) can be selected as the textual query refinement, and the first refined search result image can be selected as the ground truth image. The query image, textual query refinement, and ground truth image can be collectively included within the training data 162 as a training example for training of the machine-learned query refinement model 120/140 by the model trainer 160. In such fashion, a corpus of image search data can be leveraged to generate a plurality of training examples for inclusion within the training data 162 for training of the machine-learned query refinement model 120.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, an image embedding for an image, an embedding for textual content (e.g., token embeddings), etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs machine-learned query refinement according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs training of a machine-learned query refinement model according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a data flow diagram for training a machine-learned query refinement model for refinement of a visual search query according to some embodiments of the present disclosure. Specifically, a query image embedding 202 for a query image, and a textual query refinement 204 associated with the query image can be obtained for processing by a machine-learned query refinement model 206. In some embodiments, the query image embedding 202 may be an image embedding for a visual query image that depicts one or more entities (e.g., object(s), a scene, person(s), etc.). Each of the one or more entities can have one or more characteristics. For example, the entity can be an object such as a car. The characteristic(s) can be the make, model, color, positioning, pose (e.g., the interior or exterior of the car), the condition of the vehicle, etc. Specifically, the entity depicted in the query image can have a first characteristic. For example, the entity may be a pair of pants, and the first characteristic may be the color blue (e.g., the query image depicts a pair of blue pants). The textual query refinement can describe a second characteristic different than the second characteristic (e.g., the color red). The ground truth image can depict the entity (e.g., the pair of pants) with the second characteristic (e.g., pants with the color red).

In some implementations, the query image embedding 202 may be an image embedding for a portion of a visual query image. For example, a user may provide an input that selects a portion of a query image. The query image embedding 202 can be generated for the portion of the query image that is selected by the user. For another example, the computing system that generates the query image embedding 202 may automatically select a portion of the query image for which to generate the query image embedding 202 based on the contents of the selected portion of the image and the unselected portion of the image. For example, the computing system may determine that the unselected portion of the image does not include any objects of interest, while the selected portion of the image includes a number of objects of interest.

In some embodiments, the textual query refinement can describe one of the characteristics of the entity. For example, the entity depicted by the query image may be an article of clothing. The characteristic of the article of clothing described by the textual query refinement can be a color, brand, size, etc. of the article of clothing.

It should be noted that although the query image embedding 202 is an image embedding within an embedding space, the query image embedding 202 may refer to any encoding or latent representation of the query image 202.

In some embodiments, the query image embedding 202 and the textual query refinement 204 can be obtained from a corpus of image search data. The corpus of image search data can describe interactions with search results from users, and can include search result images provided to users responsive to a query, and refined search result images provided to the users responsive to selection of query refinement elements provided to the users with the search result images. The query image for the query image embedding 202, the textual query refinement 204, and the ground truth image for the ground truth image embedding 210 can be selected from the search result images, the selectable query refinement elements, and the refined search result images.

For example, a plurality of users may each provide a textual query of “car” to an image search application, and in response, the image search application can provide a plurality of search result images to the users. The corpus of image search data can indicate a first search result image of the plurality of search result images as being interacted with most by the users. Next, the plurality of users can each select the same query refinement element of “blue”. The image search application can provide a plurality of refined search result images depicting blue cars, and the corpus of image search data can indicate a first refined search result image of the plurality of refined search result images as being interacted with most by the plurality of users. The first search result image can be selected as a query image for the query image embedding 202, the textual content of the query refinement element (e.g., “blue”) can be selected as the textual query refinement 204, and the first refined search result image can be selected as the ground truth image for the ground truth image embedding 210.

The machine-learned query refinement model 206 can process the textual query refinement 204 and the query image embedding 202 to obtain the refined image embedding 208. The refined image embedding 208 is an image embedding that incorporates the textual query refinement 204. For example, the query image embedding 202 may depict a blue dress. The textual query refinement 204 can include the word “red”. The refined image embedding 208 can correspond to an image embedding for an image of a red dress. Put in other words, the refined image embedding may be an alternative representation of an image for a red dress. As will be appreciated from the present disclosure, the refined image embedding may be used for retrieving, based on low-level features of the images in a corpus of images, one or more images that are similar to an image represented by the refined image embedding.

A loss function evaluator 212 can evaluate a loss function that evaluates a difference between the refined image embedding 208 and the ground truth embedding 210. Specifically, the loss function evaluates a distance between the refined image embedding 208 and the ground truth image embedding 210 within an image embedding space 214.

Based at least in part on the loss function, the modification determinator 216 can modify one or more values of one or more parameters of the machine-learned query refinement model 206 via the parameter value modification(s) 218.

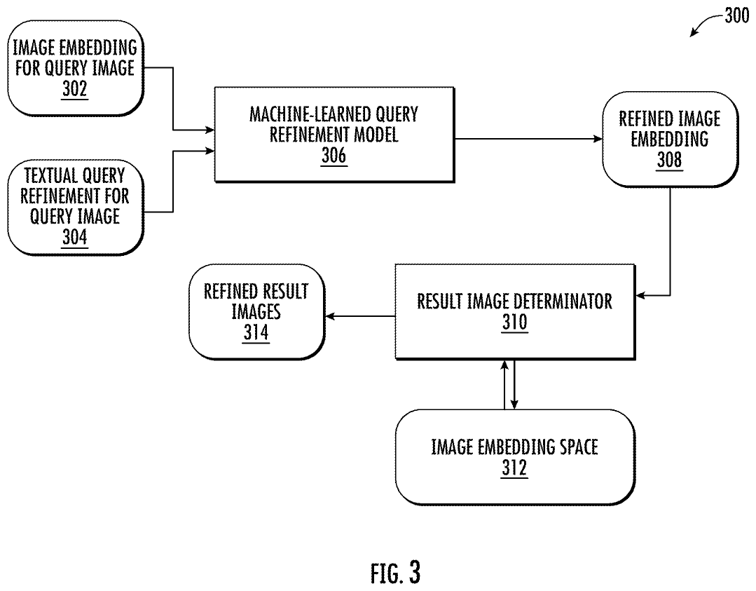

FIG. 3 depicts data flow diagram 300 for refining a visual search query with a machine-learned query refinement model according to some embodiments of the present disclosure. Specifically, an image embedding can be obtained for a query image provided by a user of a visual search application. For example, the visual search application may be an application feature offered by an operating system. For another example, the visual search application may be an application communicatively coupled to a second application accessed by the user. For yet another example, the visual search application may include the machine-learned query refinement model 306, or may communicate with a service that provides the machine-learned query refinement model 306.

A textual query refinement 304 for the query image can be obtained from a user of the visual search application. The textual query refinement can be responsive to provision of one or more initial result images for the query image to the user of the visual search application. The textual query refinement 304 and the image embedding 302 can be processed with the machine-learned query refinement model 306 to obtain the refined image embedding 308. The refined image embedding can incorporate the textual query refinement 304 as discussed with regards to the refined image embedding 208 of FIG. 2.

The result image determinator 310 can determine one or more refined result images 314 based at least in part on the refined image embedding 308. In some embodiments, determining the one or more refined result images includes determining one or more image embeddings within a threshold distance of the refined image embedding 308 within the image embedding space 312, and selecting the one or more refined result images 314 that respectively correspond to the one or more image embeddings within the threshold distance.

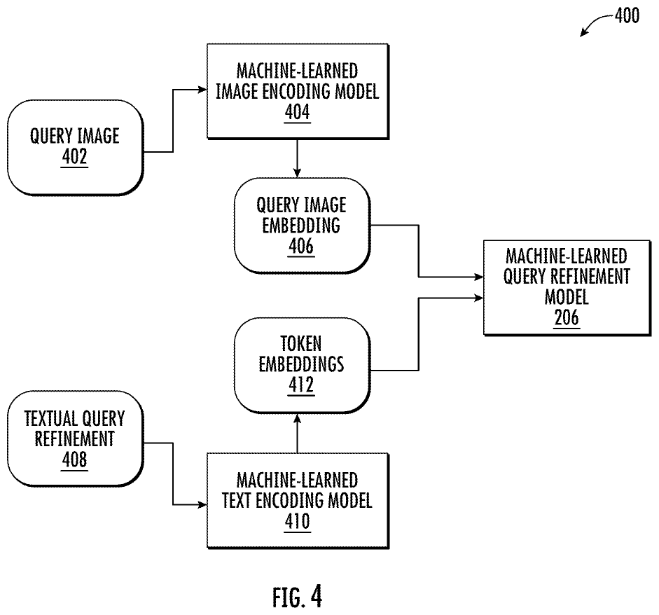

FIG. 4 depicts data flow diagram 400 for processing inputs for a machine-learned query refinement model for refinement of a visual search query according to some embodiments of the present disclosure. Specifically, the query image embedding 406 (e.g., the query image embedding 202 of FIG. 2, the image embedding 302 of FIG. 3, etc.) can be determined from a query image. In some embodiments, a machine-learned model, such as a machine-learned image encoding model 404, can process the query image 402 to generate the query image embedding 406. For example, the machine-learned image encoding model may be a model trained to generate image embeddings for an image embedding space. The image embedding space may be an image embedding space utilized for a visual search application. The query image embedding can be processed with the machine-learned query refinement model 206 as described with regards to FIG. 2.

In some embodiments, the textual query refinement 408 can be processed using a machine-learned model, such as a machine-learned text encoding model 410, to obtain a latent representation or encoding of the textual query refinement 408. In some embodiments, the machine-learned text encoding model 410 may be trained to process a textual query refinement to generate a plurality of token embeddings 412. Alternatively, in some embodiments, the machine-learned text encoding model 410 may process the textual query refinement 408 to generate some other type of latent representation 410 of the textual query refinement.

In some embodiments, the machine-learned image encoding model may be a submodel or portion, of the machine-learned query refinement model 206. For example, while processing the query image 402 and the textual query refinement 408 as described with regards to FIG. 2, the portion of the machine-learned query refinement model 206 that includes the machine-learned image encoding model 404 may process the query image 402 to obtain the query image embedding 406, and then may process the query image embedding 406 alongside the token embeddings 412 to obtain a refined image embedding as described with regards to FIG. 3.

Similarly, in some embodiments, the machine-learned text encoding model may be a submodel or portion of the machine-learned query refinement model 206. For example, while processing the query image 402 and the textual query refinement 408 as described with regards to FIG. 2, the portion of the machine-learned query refinement model 206 that includes the machine-learned text encoding model 410 may process the textual query refinement 408 to obtain the token embeddings 412, and then may process the query image embedding 406 alongside the token embeddings 412 to obtain the refined image embedding.

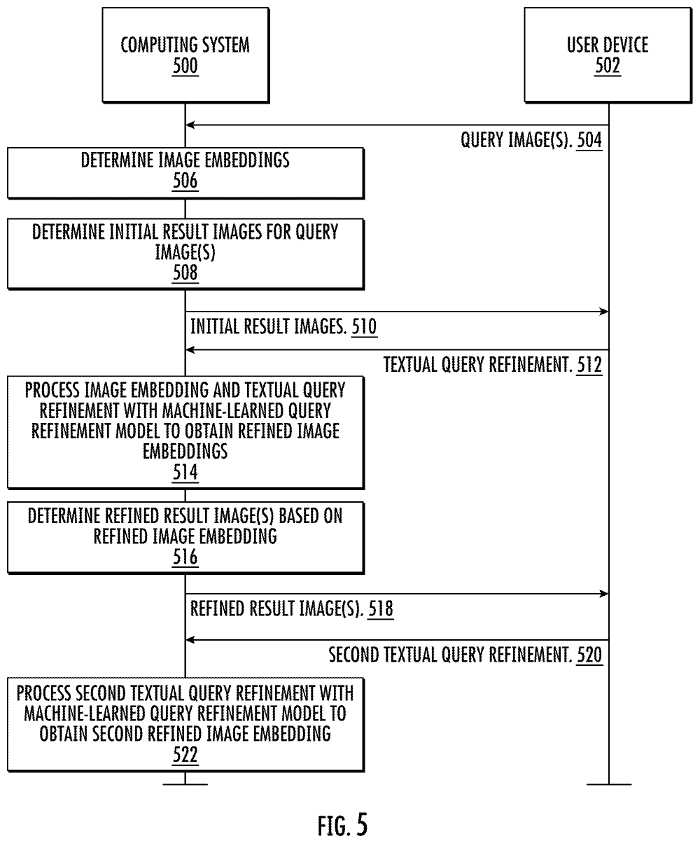

FIG. 5 depicts a communication flow diagram for provision of visual search services with query refinement according to some embodiments of the present disclosure. Specifically, at step 504 a computing system 500 (e.g., computing system 100 of FIG. 1, etc.) can receive query image(s) from a user of a user device 502 (e.g., user device 102 of FIG. 1, etc.). It should be noted that communicative entities 500 and 502 are only depicted to more easily illustrate the flow of information, and could represent any other type of computing device or system. For example, the computing system 500 and the user device 502 could be the user device 102 of FIG. 1, and the flow of information depicted in FIG. 5 may be or otherwise include inter-process communication on the same device. Alternatively, the computing system 100 may be the server computing system 130 of FIG. 1, and may provide a service which facilitates visual search applications that are executed on the user device 102 of FIG. 1. As such, it should be broadly understood that embodiments of the present disclosure may be implemented across any configuration of computing device(s) of the present disclosure.

Once the query image(s) are received, at step 506 the computing system 500 can determine image embedding(s) for the respective query image(s) as previously discussed with regards to FIG. 4. At step 508, the image embedding(s) can be utilized to determine initial result images. For example, the computing system 500 can determine the image embeddings for the initial result images that are closest to the image embedding(s) for the query image(s) within an image embedding space.

At step 510, the computing system 500 can provide the initial result images to the user device 502. In some embodiments, the computing system can provide the initial result images within an interface of the visual search application (e.g., executed by user device 502, etc.).

At step 512, responsive to provision of the initial result images, the computing system 500 can obtain a textual query refinement responsive to provision of the initial result images at step 510. For example, the initial result images may be provided to a user of a visual search application within the interface of the visual search application. The visual search application may provide an indication to the user of the application to provide a textual query refinement via a textual input field presented within the interface. The user can provide the textual query refinement via the textual input field, and the textual query refinement can be provided to the computing system 500.

At step 514, the computing system can process the image embedding and the textual query refinement for the query image with the machine-learned query refinement model to obtain a refined image embedding that incorporates the textual query refinement as previously described with regards to FIGS. 3 and 4.

In some embodiments, the computing system can also process information associated with the image that corresponds to the image embedding. For example, the image that corresponds to the image embedding may be hosted on a web site that includes a description of the image. The information associated with the image can include the description, or can otherwise be generated based on the description. For another example, the image that corresponds to the image embedding may be processed with a semantic image processing model that is operable to generate a semantic output descriptive of the image. The information can include the semantic output. For yet another example, the image that corresponds to the image embedding may be hosted on a web site or application that enables users to post textual content that is associated with the image (e.g., tags, comments, etc.). The information can include or otherwise the describe the textual content posted by users. The machine-learned query refinement model can process the information, the image embedding, and the textual query refinement for the query image to obtain the refined image embedding.

At step 516, the computing system 500 can determine refined result image(s) based on the refined image embedding as previously described with regards to FIG. 3. At step 518, the computing system 500 can provide the refined result image(s) to the user device 502. In some embodiments, the refined result images can be provided to the user device 502 for display within the interface of the visual search application.

In some embodiments, at step 520, the computing system 500 can obtain a second textual query refinement responsive to provision of the refined result image(s). For example, the refined result images can be provided to the user of a visual search application within the interface of the visual search application. The visual search application may provide an indication to the user of the application to provide a second textual query refinement via the textual input field presented within the interface. The user can provide the second textual query refinement via the textual input field, and the second textual query refinement can be provided to the computing system 500.

In some embodiments, at step 522, the computing system 500 can process the second textual query refinement and the image embedding of the query image with the machine-learned query refinement model to obtain a second refined image embedding that incorporates the second textual query refinement. Alternatively, in some embodiments at step 22 the computing system 500 can process the refined image embedding and the second textual query refinement with the machine-learned query refinement model to obtain a second refined image embedding that incorporates the textual query refinement and the second textual query refinement.

### Example Methods

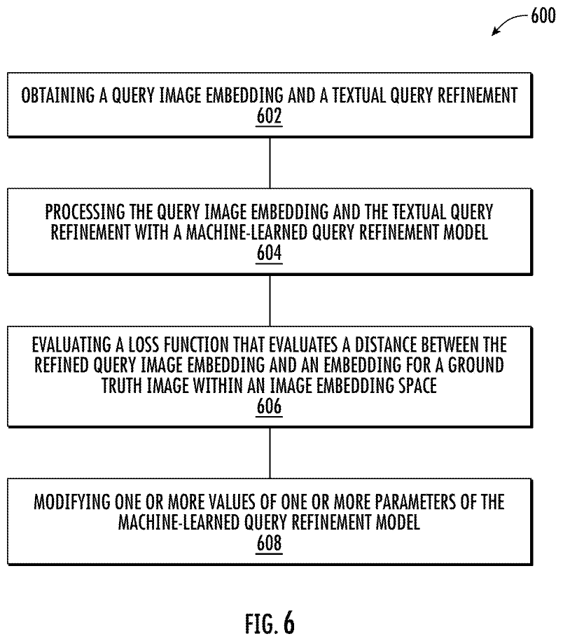

FIG. 6 depicts a flow chart diagram of an example method 600 to perform training of a machine-learned query refinement model according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a query image embedding and a textual query refinement. Specifically, the computing system can obtain a query image embedding for a query image and a textual query refinement associated with the query image. In some embodiments, obtaining the query image embedding includes determining a textual embedding for the textual query refinement, and processing the query image embedding and the textual query refinement with the machine-learned query refinement model includes processing the query image embedding and the textual embedding for the textual query refinement with the machine-learned query refinement model to obtain a refined query image embedding that incorporates the textual query refinement.

At 604, the computing system can process the query image embedding and the textual query refinement. Specifically, the computing system can process the query image embedding and the textual query refinement with a machine-learned query refinement model to obtain a refined query image embedding that incorporates the textual query refinement.

At 606, the computing system can evaluate a loss function. Specifically, the computing system can evaluate a loss function that evaluates a distance between the refined query image embedding and an embedding for a ground truth image within an image embedding space. In some embodiments, prior to evaluating the loss function, the computing system obtains a corpus of image search data that includes search result images provided to users responsive to a query, and refined search result images provided to the users responsive to selection of query refinement elements provided to the users with the search result images. In some embodiments, the computing system selects the query image, the textual query refinement, and the ground truth image from the search result images, the query refinement elements, and the refined search result images.

At 608, the computing system can modify one or more values of one or more parameters of the machine-learned query refinement model based at least in part on the loss function.

In some embodiments, the computing system obtains a user query image and a textual query refinement from a user for the user query image. The textual query refinement is responsive to provision of one or more initial result images to the user responsive to the user query image. The computing system processes the user query image and the textual query refinement for the user query image with the machine-learned query refinement model to obtain a refined image embedding of the user query image that incorporates the textual query refinement.

In some embodiments, the computing system can obtain one or more refined result images responsive to the refined image embedding of the user query image. In some embodiments, to obtain the refined result image(s), the computing system can select one or more image embeddings within a threshold distance of the refined image embedding of the user query image within the image embedding space. The one or more image embeddings can be respectively associated with the one or more refined result images. In some embodiments, the computing system can provide the one or more refined result images. In some embodiments, to provide the refined result images, the computing system provides the one or more refined result images for display within an interface of a search application of a user device of the user.

In some embodiments, the computing system can receive data indicative of a selection of at least one refined result image of the one or more result images by the user. In some embodiments, the computing system can modify one or more values of the one or more parameters of the machine-learned query refinement model based at least in part on the at least one refined result image.

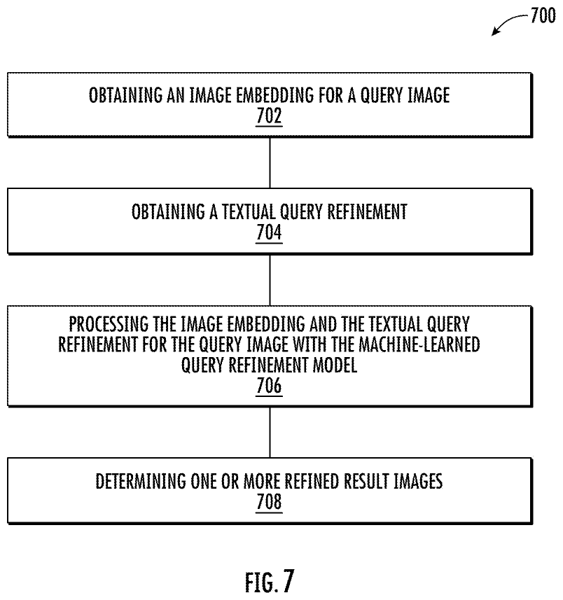

FIG. 7 depicts a flow chart diagram of an example method 700 to perform query refinement with a machine-learned query refinement model according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an image embedding for a query image provided by a user of a visual search application. In some embodiments, to obtain the image embedding, the computing system obtains the query image from the user of the visual search application and determines the image embedding based at least in part on the query image, wherein the image embedding is representative of the query image.

At 704, the computing system can obtain, from the user of the visual search application, a textual query refinement for the query image. The textual query refinement is responsive to provision of one or more initial result images for the query image to the user of the visual search application. In some embodiments, the computing system determines one or more token embeddings representative of the textual query refinement.

At 706, the computing system can process the image embedding and the textual query refinement for the query image with the machine-learned query refinement model to obtain a refined image embedding that incorporates the textual query refinement.

At 708, the computing system can determine one or more refined result images based at least in part on the refined image embedding that incorporates the textual query refinement. In some embodiments, to determine the one or more refined result images the computing system determines one or more image embeddings within a threshold distance of the refined image embedding of the query image within the image embedding space, and selects the one or more refined result images that respectively correspond to the one or more image embeddings.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for machine-learned multimodal searching of images, comprising:
one or more processors;
a machine-learned query refinement model trained to refine an image query with a textual query refinement; and
one or more non-transitory computer-readable media that store instructions that, when executed by the one or more processors, cause the computing system to perform operations, the operations comprising:
obtaining an image embedding for a query image provided by a user of a visual search application;
obtaining, from the user of the visual search application, a textual query refinement for the query image, wherein the textual query refinement is responsive to provision of one or more initial result images for the query image to the user of the visual search application;
processing the image embedding and the textual query refinement for the query image with the machine-learned query refinement model to obtain a refined image embedding that incorporates the textual query refinement; and
determining one or more refined result images based at least in part on the refined image embedding that incorporates the textual query refinement.

2. The computing system of claim 1, wherein determining the one or more refined result images comprises:
determining one or more image embeddings within a threshold distance of the refined image embedding of the query image within an image embedding space; and
selecting the one or more refined result images that respectively correspond to the one or more image embeddings.

3. The computing system of claim 1, wherein obtaining the image embedding for the query image comprises:
obtaining the query image from the user of the visual search application; and
determining the image embedding based at least in part on the query image, wherein the image embedding is representative of the query image.

4. The computing system of claim 1, wherein obtaining the textual query refinement for the query image further comprises determining one or more token embeddings representative of the textual query refinement; and
wherein processing the image embedding and the textual query refinement comprises processing the image embedding and the one or more token embeddings with the machine-learned query refinement model to obtain the refined image embedding for the query image that incorporates the textual query refinement.

5. The computing system of claim 1, wherein the machine-learned query refinement model comprises a transformer model.

6. The computing system of claim 1, wherein the operations further comprise:
providing the one or more refined result images to a user device for display within an interface of the visual search application.

7. The computing system of claim 6, wherein the operations further comprise:
obtaining, responsive to provision of the one or more refined result images, a second textual query refinement for the query image.

8. The computing system of claim 7, wherein the operations further comprise processing the second textual query refinement and the image embedding of the query image with the machine-learned query refinement model to obtain a second refined image embedding that incorporates the second textual query refinement.

9. The computing system of claim 7, wherein the operations further comprise processing the refined image embedding and the second textual query refinement with the machine-learned query refinement model to obtain a second refined image embedding that incorporates the textual query refinement and the second textual query refinement.

10. A computer-implemented method, comprising:
obtaining, by a computing system comprising one or more computing devices, a query image embedding for a query image and a textual query refinement associated with the query image;
processing, by the computing system, the query image embedding and the textual query refinement with a machine-learned query refinement model to obtain a refined query image embedding that incorporates the textual query refinement;
evaluating, by the computing system, a loss function that evaluates a distance between the refined query image embedding and an embedding for a ground truth image within an image embedding space; and
modifying, by the computing system, one or more values of one or more parameters of the machine-learned query refinement model based at least in part on the loss function.

11. The computer-implemented method of claim 10, wherein:
the query image depicts an entity with a first characteristic;
the textual query refinement is descriptive of a second characteristic for the entity different than the first characteristic; and
the ground truth image depicts the entity with the second characteristic.

12. The computer-implemented method of claim 10, wherein obtaining the query image embedding and the textual query refinement further comprises:
determining, by the computing system, a textual embedding for the textual query refinement; and
wherein processing the query image embedding and the textual query refinement with the machine-learned query refinement model comprises processing, by the computing system, the query image embedding and the textual embedding for the textual query refinement with the machine-learned query refinement model to obtain a refined query image embedding that incorporates the textual query refinement.

13. The computer-implemented method of claim 12, wherein textual embedding for the textual query refinement comprises a plurality of token embeddings.

14. The computer-implemented method of claim 10, wherein, prior to evaluating the loss function, the method comprises:
obtaining, by the computing system, a corpus of image search data comprising search result images provided to users responsive to a query, and refined search result images provided to the users responsive to selection of query refinement elements provided to the users with the search result images; and
selecting, by the computing system, the query image, the textual query refinement, and the ground truth image from the search result images, the query refinement elements, and the refined search result images.

15. (canceled)

16. The computer-implemented method of claim 10, wherein the method further comprises:
obtaining, by the computing system from a user, a user query image and a textual query refinement for the user query image, wherein the textual query refinement is responsive to provision of one or more initial result images to the user responsive to the user query image; and
processing, by the computing system, the user query image and the textual query refinement for the user query image with the machine-learned query refinement model to obtain a refined image embedding of the user query image that incorporates the textual query refinement.

17. The computer-implemented method of claim 16, wherein the method further comprises:
obtaining, by the computing system, one or more refined result images responsive to the refined image embedding of the user query image; and
providing, by the computing system, the one or more refined result images.

18. The computer-implemented method of claim 17, wherein providing the one or more refined result images comprises providing, by the computing system, the one or more refined result images for display within an interface of a search application of a user device of the user.

19. The computer-implemented method of claim 17, wherein obtaining the one or more refined result images comprises selecting, by the computing system, one or more image embeddings within a threshold distance of the refined image embedding of the user query image within the image embedding space, wherein the one or more image embeddings are respectively associated with the one or more refined result images.

20. The computer-implemented method of claim 18, wherein the method further comprises:
receiving, by the computing system, data indicative of a selection of at least one refined result image of the one or more refined result images by the user; and
modifying, by the computing system, one or more values of the one or more parameters of the machine-learned query refinement model based at least in part on the at least one refined result image.

21. One or more non-transitory computer-readable media that store instructions that, when executed by one or more processors of a computing system, cause the computing system to perform operations, the operations comprising:
obtaining an image embedding for a query image provided by a user of a visual search application;
obtaining, from the user of the visual search application, a textual query refinement for the query image, wherein the textual query refinement is responsive to provision of one or more initial result images for the query image to the user of the visual search application;
processing the image embedding and the textual query refinement for the query image with a machine-learned query refinement model to obtain a refined image embedding that incorporates the textual query refinement; and
determining one or more refined result images based at least in part on the refined image embedding that incorporates the textual query refinement.
